(19) United States
(12) Patent Application Publication
(10) Pub. No.: US 2021/0283848 A1
(43) Pub. Date: Sep. 16, 2021

(54) PRINTER HAVING A CONTROLLABLE RESISTIVE LOAD

(71) Applicant: Hewlett-Packard Development Company, L.P., Spring, TX (US)

(72) Inventors: Marina FERRAN FARRES, Vancouver, WA (US); Esteve COMAS, Sant Cugat del Valles (ES); Juan Manuel ZAMORANO, Sant Cugat del Valles (ES)

(21) Appl. No.: 16/316,152

(22) PCT Filed: Sep. 13, 2016
(86) PCT No.: PCT/US2016/045488

§ 371 Date: Jan. 8, 2019

(51) Int. Cl. B29C 64/393; B29C 64/295; B33Y 50/02

(52) U.S. Cl. CPC B29C 64/393; B33Y 40/00; B33Y 50/02; B29C 64/295

(57) ABSTRACT

A printer is disclosed. The printer comprises a resistive load and a control system. The control system is to control the resistive load. The control system is to determine a resistance value of the resistive load. The control system is to determine a voltage transition mode for transitioning the voltage applied across the resistive load to a target voltage value depending on the resistance value. The control system is to transition the voltage applied across the resistive load to the target voltage value according to the determined voltage transition mode.

### BACKGROUND

Printers may comprise a resistive load to generate heat. In the additive manufacturing technology, using three-dimensional (3D) printers, for example, three-dimensional objects are built by adding successive layers of build material to form a series of cross-sections which are joined to create a final object. The build material may be a powder, such as plastic, metal, or other composite materials, and the material may be fused to create the final shape. Other additive manufacturing technologies may form a layer of powder, and then selectively solidify portions of the layer to form a fused/sintered cross-section of an object.

Heat from the resistive load, for example an infrared or near-infrared lamp, is applied to cause fusing of the powder material where a fusing agent is deposited. The quality of the objects produced by additive manufacturing may depend, among others, on the supply of constant well-defined heat amount.

### BRIEF DESCRIPTION OF DRAWINGS

Some examples are described with respect to the following figures:

FIG. 1 shows a schematic diagram of an example of a control system;

FIG. 2 shows a flow chart of an example of a method of controlling a resistive load;

FIG. 3 shows a flow chart of a further example of a method of controlling a resistive load;

FIG. 4 shows a schematic diagram of a further example of a control system;

FIG. 5 shows a schematic diagram of a further example of a control system;

FIG. 6 shows a schematic diagram of a further example of a control system;

FIG. 7 shows a schematic chart of an example of voltage and electrical current when instantly switching a voltage across a resistive load;

FIG. 8 shows a schematic chart of an example of voltage and electrical current when gradually increasing a voltage across a resistive load;

FIG. 9 shows a schematic chart of an example of voltage and electrical current when stepwise increasing a voltage across a resistive load; and

FIG. 10 shows a schematic diagram of an example of a three-dimensional printer.

### DETAILED DESCRIPTION OF DRAWINGS

Examples described herein relate to a printer, a control system and a method of controlling a voltage applied across a resistive load.

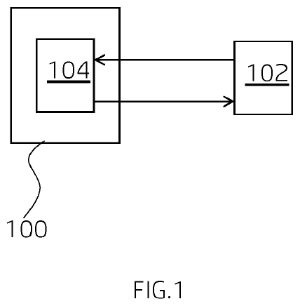

FIG. 1 shows a schematic diagram of an example of a control system 100 to control a resistive load 102. The control system 100 may be an internal part of a printer or connected with a printer. The control system 100 comprises a controller 104. The controller 104 controls a voltage applied across the resistive load 102.

In some examples, the resistive load 102 is capable of generating heat as a function of at least one of the voltage applied across the resistive load 102, the electrical current through the resistive load 102 and the ohmic resistance of the resistive load 102. According to one example, the resistive load 102 comprises a heating device for generating heat based on an ohmic resistance of the resistive load 102 and the electrical current through the resistive load 102. The ohmic resistance of the resistive load 102 may be quantified by its resistance value. According to another example, the resistive load 102 can be considered to be a heating device. In these examples, the control system 100 controls the amount of heat generated by the resistive load 102 or the corresponding heating device based on a target voltage value of the voltage to be applied across the resistive load 102. In one example, the resistive load 102 is or includes an infrared or near-infrared lamp to generate heat radiation.

The resistive load 102 may have multiple operation states. In some examples, the operation states include an on state and off state. The resistive load 102 may generate different amounts of heat corresponding to the value of the voltage that is applied across the resistive load 102. Different voltage values for the voltage to be applied across the resistive load 102 may be associated with the respective operation state of the resistive load 102.

Generally, the temperature of a resistive load changes when the voltage value of the voltage that is applied across the resistive load changes. The temperature of the resistive load transitions from an initial value, i.e. temperature value before the applied voltage is changed, to a steady value, which corresponds to a stable state of the resistive load. Accordingly, the ohmic resistance of the resistive load 102 depends on its temperature. For example, the ohmic resistance of the resistive load 102 has a positive temperature coefficient, i.e. the ohmic resistance increases with increasing temperature of the resistive load 102. In some example, the resistive load 102 employs filaments for generating heat. Because the temperature of the resistive load 102 depends on the internal temperature and takes some time to change, when the voltage across the resistive load is changed, a transition of the temperature is observed until the filament is in a steady state. If the resistive load 102 is used as a heating device, and if a heating voltage is applied to the resistive load 102 at a time when the resistive load is still cold, the resistive load 102 will have a relatively low ohmic resistance and hence a relatively high electrical current will flow through the resistive load 102. If the heating voltage continues to be applied to the resistive load 102, the resistive load 102 will heat up, its ohmic resistance will increase and the electrical current flowing through the resistive load 102 will hence decrease. The relatively high electrical current that flows through the resistive load 102 at the time of applying the heating voltage when the resistive load 102 is still cold (i.e. switch on) is designated an in-rush current.

The controller 104 receives a target voltage value of a voltage that is to be applied across the resistive load 102. In some examples, the target voltage value is communicated from an external device to the control system 100. In another example, the target voltage value is generated by the control system 100. In the following, the term “applied voltage” refers to the voltage applied across the resistive load 102.

The controller 104 determines an initial voltage value that is applied across the resistive load 102. The initial voltage value refers to a voltage value present at the resistive load 102 at the time when it is desired to switch or transition to the target voltage value. In some examples, the initial voltage value is a voltage value which is applied across the resistive load 102 when the target voltage value is received by the control system 100. The initial voltage value may depend on a current operation state of the resistive load.

Both the target voltage and the initial voltage value can be indicated in absolute terms, e.g. 0 V, 24 V, 240 V, etc., or relative to a maximum voltage value which can be applied to the resistive load 102, e.g. 0%, 20% or 100% with respect to the maximum voltage value. The initial voltage value may refer to a state in which no voltage is applied across the resistive load 102 or the resistive load 102 is grounded, i.e. the initial voltage value may be 0 V in some examples. In another example, the initial voltage value may be a defined bias voltage, e.g. 20% of the maximum voltage value.

The controller 104 determines a resistance value of the resistive load 102. The resistance value refers to a quantity of an ohmic resistance of the resistive load 102. For example, the resistance value is indicated in the unit of Ohms. The resistance value of the resistive load 102 depends on the temperature of the resistive load 102. Further, the temperature of the resistive load 102 depends on the voltage applied across the resistive load 102 and the electrical current through the resistive load 102.

Different methods exist for the controller 104 to determine the resistance value of the resistive load 102. For example, the controller 104 includes or is connected to a resistance meter or an ohmmeter that is coupled to the resistive load 102. In another example, the controller 104 includes or is connected to an ammeter that is coupled to the resistive load 102. In some examples, the controller 104 comprises a processor to calculate the resistance value based on measurement data from the resistance meter or ammeter.

According to one example, in a stable state, the ohmic resistance of the resistive load 102 may depend on the voltage applied and hence can be calculated based on the known voltage applied to the resistive load. For example, the ohmic resistance of the resistive load 102 is determined according to:

$$R ( U , P ) = \frac{{U}^{2}}{P}$$

wherein R(U, P) is the ohmic resistance of the resistive load, U is the voltage applied across the resistive load 102 and P is the output power of the resistive load 102.

In some examples, the ohmic resistance in a stable state of the resistive load 102 corresponds to the voltage applied multiplied with a constant factor K, such as R=U·K. In another example, the ohmic resistance of the resistive load 102 may correspond to the applied voltage to the power of X1 multiplied with a constant factor K, such as R=U^{X1}·K, wherein X1 can be in the range of 0.1 to 1.0, 0.2 to 0.8, or 0.4 to 0.6, or approximately 0.5.

According to one example, the resistive load 102 comprises Tungsten filaments. The ohmic resistance in a stable state of the resistive load 102 may correspond to the voltage applied across the resistive load 102 to the power of X1 multiplied with a nominal voltage of the resistive load 102 to the power of X2 and divided by a nominal power of the resistive load 102. For example, the first exponent X1 is in the above-mentioned range. For example, the first exponent X1 can be 0.46, or approximately 0.46, and the second exponent X2 is 1.54, or approximately 1.54. The nominal voltage and the nominal power of the resistive load 102 are characteristics of the resistive load 102. An example for the relation between the ohmic resistance of the resistive load 102, the nominal values and the applied voltage is given by the equation:

$$R ( U ) = \frac{{( {U}_{nominal} )}^{X 2}}{{P}_{nominal}} \cdot {U}^{X 1}$$

wherein R(U) is the resistance value as a function of the applied voltage U, Uₙₒₘᵢₙₐₗ is the nominal voltage of the resistive load 102, Pₙₒₘᵢₙₐₗ is the nominal power of the resistive load 102 and U is the voltage applied across the resistive load 202. According to one example, the nominal voltage of the resistive load 102 corresponds to the maximum voltage that can be applied across the resistive load 102. Accordingly, the nominal power may correspond to a maximum power of the resistive load 102 which is achieved by applying the maximum voltage across the resistive load 102. The first and second exponents X1, X2 may be chosen to be 0.46, or approximately 0.46, and 1.54, or approximately 1.54, respectively. For other types of heating elements, different relationships of the ohmic resistance and different formula may be determined.

According to another example, the electrical current through the resistive load 102 is measured and inserted into the equation to determine the resistance value R of the resistive load 102:

$$R = \frac{U}{I}$$

wherein I is the measured electrical current.

The controller 104 may calculate the in-rush electrical current Iᵢₙ₋ᵣᵤₛₕ, which would result from instantly switching the voltage applied across the resistive load 102 to the target voltage value, by inserting the determined resistance value R_{det} and the target voltage value U_{target} into the equation:

$${I}_{i n - r u s h} = \frac{{U}_{target}}{{R}_{det}}$$

In the following, example calculations are performed that may be executed by the controller 104. The resistive load 102 may have a root mean square (rms) nominal voltage Vₙₒₘᵢₙₐₗ of 240 V and a nominal power Pₙₒₘᵢₙₐₗ of 2 kW. The resulting nominal current Iₙₒₘᵢₙₐₗ is, according to I=P/U, approx. 8.3 A. The maximum admissible electrical current Iₘₐₓ can be defined as three times the nominal electrical current Iₙₒₘᵢₙₐₗ, 25 A. In other examples, the maximum admissible electrical current Iₘₐₓ is equal to 1.5 times, two times, or any other real number multiplied with the nominal electrical current Iₙₒₘᵢₙₐₗ of the resistive load 102. Different approaches can be used for determining the maximum admissible electrical current.

According to an example, a current (initial) voltage value is 48 V corresponding to 20% the nominal voltage and to be transitioned to a target voltage value of 240 V, i.e. to the nominal voltage. At a time when transitioning to the target voltage is desired, the controller 104 determines whether or not it is admissible to transition the voltage applied across the resistive load 102 from the current (initial) voltage value of 48 V to the target voltage value of 240 V by instantly switching, without exceeding the maximum admissible electrical current Iₘₐₓ of 25 A.

To determine whether such an instantly switching is admissible, the ohmic resistance of the resistive load 102 at the current voltage, i.e. at the time immediately before switching, is determined. This can be done, for example, by measuring the electrical current through the resistive load. According to the measured electrical current, the controller 104 can calculate, in this example, a current resistance value of approx. 15.22 Ohms. Based on this resistance value, the controller 104 can determine that the in-rush electrical current resulting from instantly switching from 48 V to 240 V would be 240 V/15.22 Ω=15.76 A, which is below the maximum admissible electrical current of 25 A. As a result, the controller 104 can decide to instantly switch the voltage across the resistive load 102 to the target voltage value of 240 V.

According to another example, the initial voltage is 12 V, corresponding to 5% of the nominal voltage of the resistive load 102. The controller 104 determines that the resistance value is, at the current voltage of 12 V, 7.26 Ohms. The resistance value can be determined by measuring the electrical current through the resistive load 102 or, in a stable state, based on the calculation of R(U) as described above. The controller 104, based on the current resistance value, calculates that the in-rush current that would result from instantly switching to the target voltage of 240 V is 240 V/7.26 Ω=33.06 A. The calculated in-rush electrical current is larger than the maximum admissible electrical current of 25 A. Accordingly, if the voltage applied across the resistive load 102 was to be instantly switched from 12 V to 240 V, an electrical current would be generated which exceeds the maximum admissible electrical current and hence the resistive load 102 could be damaged. Therefore, the controller 104 can apply one of a number of different switching strategies, referred to as voltage transition modes, wherein the target voltage value is not switched to instantly, or in one go, but instead the voltage is transitioned from the initial voltage value to the target voltage value in accordance with a ramp or a step function.

For example, the controller decides that the voltage applied across the resistive load 102 is to be transitioned to the target voltage value according to a step function. In this example, the applied voltage is, in a first step, switched from the initial voltage value to an intermediate voltage value and, in a second step, switched from the intermediate voltage value to the target voltage value. The controller 104 may determine a range of the intermediate voltage value as described below.

The controller 104 may determine a maximum intermediate voltage, to which the applied voltage may be transitioned and thereby generate the maximum admissible electrical current. The maximum intermediate voltage Uₘₐₓ may be determined according to Uₘₐₓ=R·Iₘₐₓ, wherein Iₘₐₓ corresponds to the maximum admissible electrical current. In the above example, the controller 104 may calculate a maximum intermediate voltage of 7.26 Ohms·25 A=181.5 V.

Further, the controller 104 may determine a minimum intermediate voltage value from which the applied voltage may be transitioned to the target voltage value and thereby generate the maximum admissible electrical current. In other words, the minimum intermediate voltage is a voltage value that is sufficiently high so that, when the applied voltage is transitioned from that minimum intermediate voltage value to the target voltage value, the in-rush electrical current still is at or below the maximum admissible electrical current. In the above example, the controller 104 may first calculate a minimum resistance value Rₘᵢₙ according to

$${R}_{min} = \frac{{U}_{target}}{{I}_{max}}$$

and obtain 240 V/25 A=9.6 Ohms. Assuming that the transition from the intermediate voltage value to the target voltage value is to be performed when the resistive load 102 is in a stable state, the calculated minimum resistance value Rₘᵢₙ can be inserted into the above equation R(U) and isolating U allows obtaining U(Rₘᵢₙ). As a result, the controller 104 may obtain a minimum intermediate voltage value of 22 V.

In addition, the controller 104 may calculate an in-rush electrical current that would result from switching the applied voltage from the initial voltage value to the minimum intermediate voltage value. In the above example, the in-rush electrical current to be expected is calculated as 7.26 Ohms/22 V=3 A which clearly lies below the maximum admissible current of 25 A. Accordingly, the controller 104 may determine a range of 22 V to 181.5 V in which the intermediate voltage value is to be located for stepwise transitioning the applied voltage from the initial voltage value to the target voltage value.

The controller 104 may further compare the calculated in-rush electrical current resulting from instantly switching the target voltage value with the maximum admissible electrical current through the resistive load 102. If the calculated in-rush electrical current exceeds or equals to the admissible electrical current, the controller 104 selects a different voltage transition mode for transitioning the voltage applied across the resistive load 102 from the initial voltage value to the target voltage value.

As explained above, the ohmic resistance of the resistive load 102 is relatively low when the resistive load 102 is cold, e.g. after being in an idle state. When a voltage is applied across the resistive load 102 and an electrical current flows through the resistive load 102, the resistive load 102 heats up due to the ohmic resistance. As a result of the temperature increase, the ohmic resistance of the resistive load 102 increases and thus, assuming that, after a transition, the applied voltage remains constant the electrical current through the resistive load 102 decreases. Accordingly, when the resistive load 102 is cold, a sharp peak of electrical current through the resistive load 102 occurs at the time when the applied voltage is instantly switched. A corresponding characteristic curve is illustrated in FIG. 7.

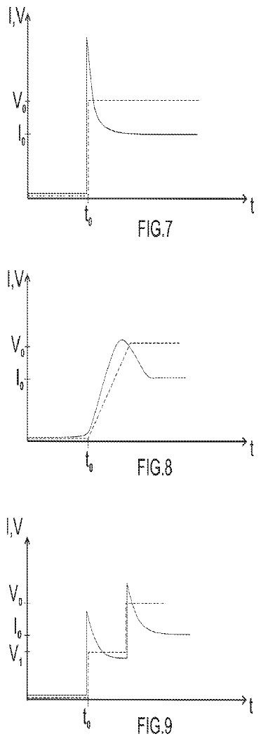

In case that the calculated in-rush electrical current resulting from instantly switching to the target voltage value exceeds the maximum admissible current, the applied voltage may be increased according to a transition mode so as to allow the resistive load 102 to heat up during a transition period In some examples, a ramp may be employed for transitioning the voltage. When applying a ramp voltage, the temperature and the resistance value of the resistive load 102 will increase according to the ramp function so that an increase in voltage is accompanied by an increase in resistance value. As a consequence, the current through the resistive load can be limited to stay below the maximum admissible current. FIG. 8 shows an example of a voltage ramp applied to the resistive load and the resulting current through the resistive load. A slope of the ramp may be quantified by a voltage change per time unit. The slope of the ramp, corresponding to the speed of the transitioning, may be varied according to the determined resistance value of the resistive load 102. An increase in the slope of the ramp will be accompanied by an increase of the in-rush electrical current.

In another example, the applied voltage may be transitioned according to a step function. Accordingly, the applied voltage is first switched to an intermediate voltage value and then to the target voltage value. In some examples, the applied voltage is switched to the target voltage value over multiple intermediate voltage values. As discussed above, the in-rush electrical current is proportional to the voltage applied across the resistive load. Accordingly, the in-rush electrical current can be reduced by switching the applied voltage to a lower voltage value than the target voltage value. A delay between the switching steps allows the resistive load 102 to heat up wherein heating is accompanied by an increase of the resistance value. The controller 104 may determine an appropriate intermediate voltage value and/or the time interval between switching to the intermediate voltage value and to the target voltage value.

In some examples, ranges of the resistance value of the resistive load 102 at the initial voltage can be defined, and a respective ramp or a respective step function can be assigned to a respective range. This assignment may be performed empirically and/or may be determined by a user or a manufacturer. The controller 104 may select the appropriate ramp or step function according to the determined resistance value.

A plurality of voltage transition modes may be provided which the controller 104 can choose from. The voltage transition mode refers to a characteristic change of the voltage applied across the resistive load 102. The voltage transition mode can be continuous, i.e. the voltage can transition from the initial voltage value to the target voltage value on a linear or nonlinear ramp, or discontinuous, i.e. the voltage transitions from the initial voltage value to the target voltage value via one or a number of intermediate voltage values step-by-step, instead of instantly switching from the initial voltage value to the target voltage value. The term “instantly” may refer to a switching process with no deliberate ramp or step function, e.g. providing a switching time from a start value to a final value within 100 ms, 20 ms, 10 ms or 1 ms.

According to one example, the controller 104 calculates an in-rush electrical current through the resistive load which would be generated when instantly switching the applied voltage from the initial voltage value to the target voltage value, taking into account the resistance value that has been determined. In this example, the controller 104 compares the calculated in-rush electrical current with a maximum admissible electrical current through the resistive load. The controller 104 then selects one voltage transition mode out of the plurality of voltage transition modes according to the result of the comparison.

The in-rush electrical current refers to an initial electrical current that flows through the resistive load 102 at the time when the voltage applied across the resistive load 102 is increased. When the resistive load 102 is cold, e.g. after being idle, the resistive load 102 may have a lower resistance value which increases with increasing temperature. As a consequence, assuming a constant applied voltage, the initial electrical current through the resistive load 102 will be higher when the resistive load is still cold than in a stable state, after the voltage has been applied for certain amount of time and the temperature and hence the resistance of the resistive load has increased, i.e. after heating up. For example, if the resistive load 102 is switched on while being cold, a relatively high electrical current will flow through the resistive load 102 because the resistive load 102 will have a low resistance value.

According to one example, the maximum admissible electrical current of the resistive load 102 refers to a maximum electrical current through the resistive load 102 without risking damaging the resistive load 102. The admissible electrical current may be a characteristic value for the resistive load 102. For example, the maximum admissible electrical current corresponds to a multiple of a nominal electrical current of the resistive load 102.

For example, if the controller 104 determines that instantly switching the applied voltage to the target voltage value would result in an in-rush electrical current through the resistive load 102 that is higher than the maximum admissible electrical current, the controller 104 determines one of a plurality of voltage transition modes which would yield an in-rush current below the maximum admissible current. For example, the respective in-rush electrical current for each of the plurality of voltage transition modes is provided to the controller 104 by a storage device. The controller 104 may compare each of the in-rush electrical currents with the admissible electrical current. In addition, the controller 104 may take into account a transition speed of each of the plurality of voltage transition modes. For example, the controller 104 excludes the voltage transition modes having an in-rush electrical current that is higher than the admissible electrical current. In another example, those voltage transition modes having a lower in-rush electrical current than the admissible electrical current are provided to the controller 104. The controller 104 may determine the voltage transition mode which allows for transitioning the applied voltage as fast as possible whereas its in-rush electrical current is below the maximum admissible electrical current.

In some examples, the plurality of voltage transition modes comprises at least two of instantly switching to the target voltage value, gradually transitioning to the target voltage value according to a linear ramp, gradually transitioning to the target voltage value according to a nonlinear ramp and stepwise transitioning according to a step function.

Instantly switching the applied voltage may involve a semiconductor switch for coupling a voltage according to the target voltage value to the resistive load 102. Accordingly, instantly switching may refer to a discontinuous transitioning of the applied voltage.

Gradually transitioning the applied voltage is performed following either a linear or a nonlinear ramp. Ramps may refer to mathematical functions describing a continuous increase or decrease of the applied voltage. According to a linear ramp, the applied voltage changes at a constant voltage change per time unit from the initial voltage value to the target voltage value. Accordingly, using a nonlinear ramp, the voltage change per time unit varies while the applied voltage is being transitioned from the initial voltage value to the target voltage value.

In some examples, ramps are provided to the controller 104 by a storage device. Accordingly, if the controller 104 decides that instantly switching the applied voltage to the target voltage value is not allowable, the ramps are communicated to the controller 104. For example, the ramps are linear ramps with different voltage change per time unit. The controller 104 may select the fastest of the ramps without exceeding the admissible electrical current.

Stepwise transitioning the applied voltage involves at least two steps of instantly switching the applied voltage. Accordingly, the applied voltage is first switched from the initial voltage value to an intermediate voltage value, and then switched again from the intermediate voltage value to the target voltage value. In some examples, the step function involves one single intermediate voltage value. In other examples, the step function involves multiple intermediate voltage values.

According to one example, the one intermediate voltage value or the multiple intermediate voltage values are provided to the controller 104 by a storage device. Accordingly, if the controller 104 determines that instantly switching the applied voltage from the initial voltage value to the target voltage value is not allowable, one or a number of step functions including the respective intermediate voltage values are communicated to the controller 104.

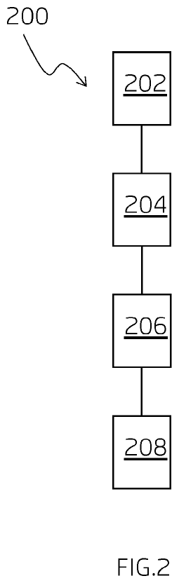

FIG. 2 shows a schematic flow diagram illustrating an example of a method 200 of controlling a voltage across a resistive load. For example, the method can be executed by the control system 100 of FIG. 1 for controlling the resistive load 102. According to one example, the method controls a resistive load of a printer.

At block 202, an initial voltage value that is applied across the resistive load is determined. The initial voltage value may be measured or received from a voltage source.

At block 204, a target voltage to be applied across the resistive load is received. As described above, the target voltage may be communicated from an external device or generated by a control system.

At block 206, a resistance value of the resistive load is determined. As described above, the resistance value may be directly measured or calculated from an electrical current through the resistive load that is being monitored. In a stable state, the resistance value can also can be calculated based on the voltage applied to the resistive load, if the resistive load and its characteristics are known.

At block 208, the voltage that is applied across the resistive load is transitioned from the initial voltage value to the target voltage value based on the resistance value that is determined at block 206. The transitioning process may include selecting one voltage transition mode out of a plurality of voltage transition modes as described above.

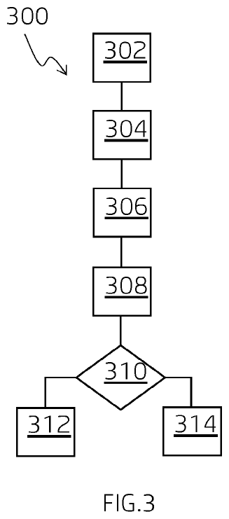

FIG. 3 shows a schematic flow diagram illustrating a further example of a method 300 of controlling a voltage across the resistive load. For example, the method 300 can be executed by the control system 100 to control the resistive load 102 as shown in FIG. 1.

At block 302, an initial voltage value that is applied across the resistive load is determined. At block 304, a target voltage value to be applied across the resistive load is received. At block 306, a resistance value of the resistive load is determined. At block 308, in-rush electrical current through the resistive load is calculated which would be generated by instantly switching the voltage applied across the resistive load from the initial voltage value to the target voltage value. The determined resistance value is taken account into the calculation of the in-rush electrical current. At block 310, the calculated in-rush electrical current is compared with the maximum admissible electrical current through the resistive load. If the calculated in-rush electrical current exceeds or equals the admissible electrical current, the voltage across the resistive load is gradually transitioned from the initial voltage value to the target voltage value according to a ramp or a step function, see block 312. If the calculated in-rush electrical current is below the admissible electrical current, the voltage across the resistive load instantly switched from the initial voltage value to the target voltage value, see block 314. As a result, the voltage across the resistive load is transitioned from the initial voltage value to the target voltage value based on the determined resistance value the resistive load.

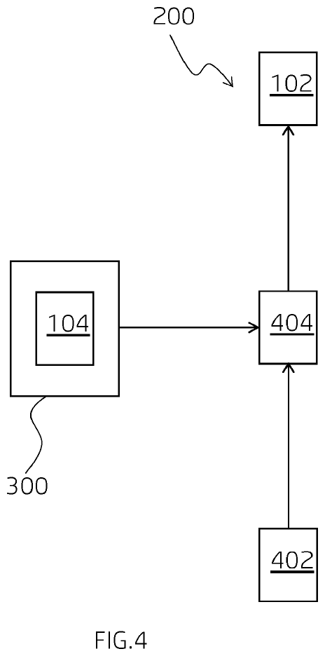

FIG. 4 shows a schematic diagram of a further example of a control system 400 to control the resistive load 102. The control system 400 is based on the control system 100 of FIG. 1 as indicated by the same reference signs. The control system 400 may be an internal part of a printer or connected with a printer (not shown). In FIG. 4, a voltage source 402 is employed to supply the voltage to be applied across the resistive load 102. The voltage applied across the resistive load 102 is controlled by the controller 104.

According to an example, the controller 104 communicates with a load driver 404 that receives the voltage supplied by the voltage source 402 and transforms the received voltage to a voltage according to the target voltage value. In this example, the controller 104 may control the transition of the voltage applied across the resistive load 102 from the initial voltage value to the target voltage value by controlling the load driver 304.

FIG. 5 shows a schematic diagram of a further example of a control system 500 to control the resistive load 102. The control system 500 is based on the control system 100 of FIG. 1 as indicated by the same reference signs. The control system 500 may be an internal part of a printer or connected with a printer. The control system 500 comprises a current sensor 502. The current sensor 502 measures an electrical current that flows through the resistive load 102. The controller 104 determines the resistance value as a function of the electrical current measured by the current sensor 502.

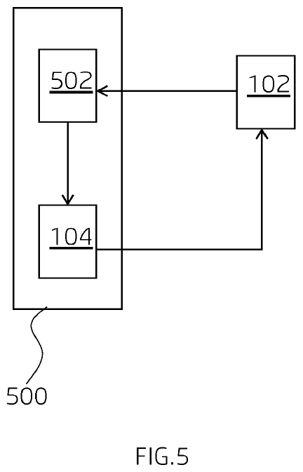

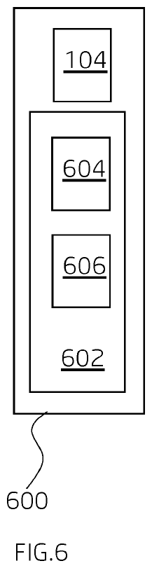

FIG. 6 shows a schematic diagram of a further example of a control system 600 to control the resistive load 102. The control system 600 comprises a storage device 602 storing a plurality of voltage transition modes 604, 606. The control system 600 may be an internal part of a printer or connected with a printer. Although FIG. 6 depicts two voltage transition modes 604, 606, wherein the plurality of voltage transition modes may comprise a larger number of voltage transition modes. The plurality of voltage transition modes 604, 606 is communicated from the storage device 602 to the control device 104. The control device 104 selects one voltage transition mode out of the plurality of voltage transition modes stored at the storage device 602.

FIGS. 7 to 9 each show a graph of the electrical current through the resistive load 102 and the voltage applied across the resistive load 102 according to different voltage transition modes of different examples.

FIG. 7 shows the electrical current resulting from instantly switching the voltage across the resistive load from an initial voltage to a target voltage. The electrical current I sharply increases when the target voltage value is applied to the resistive load and then decreases towards a stable current I₀, as the resistive load start heating up, with a corresponding increase of the ohmic resistance. The peak of the electrical current corresponds to the in-rush electrical current.

FIG. 8 shows the electrical current resulting from gradually transitioning the voltage across the resistive load from an initial voltage to a target voltage in accordance with a linear ramp. The in-rush electrical current is displayed as a smooth curve rather than a peak as shown in FIG. 7. The amplitude of the in-rush electrical current changes as a function of the voltage change per time unit, or slope of voltage ramp. The amplitude of the in-rush electrical current is reduced in comparison with instantly switching.

FIG. 9 shows the electrical current resulting from transitioning the voltage across the resistive load from an initial voltage to a target voltage in accordance with a step function. Accordingly, the voltage applied across the resistive load is, in a first step, increased from the initial voltage value of zero to an intermediate voltage value Vi, and, in a second step, increased further to the target voltage value Vo. Both the first and second steps can involve process of instantly switching the applied voltage. The in-rush electrical current in each step is less than when instantly switching from the initial voltage value to the target voltage value as shown in FIG. 7. The reason for the reduced in-rush current is that, during the first switching step, a lower voltage is applied to the resistive load; and, when the second switching step occurs, applying the “full” target voltage, the resistive load already had time to heat up, which is accompanied by a corresponding increase of the ohmic resistance, so that the current through the resistive load is decreased accordingly.

Accordingly, the in-rush electrical current can be reduced by transitioning the applied voltage according to a ramp or a step function. However, such gradual transitions require longer time until the desired temperatures reached. Hence, a control system of the respective heating device may select the fastest voltage transition mode without exceeding predetermined electrical current.

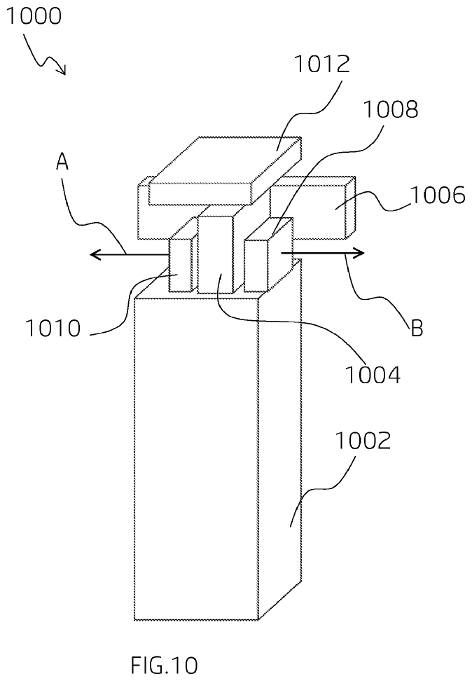

FIG. 10 shows a schematic diagram of an example of a printer 1000 which may be a 3D printer. The printer 1000 comprises a build unit 1002 and a carriage 1004. The printer 1000 may further comprise a process room (not shown) that encloses the build unit 1002 and the carriage 1004. In some examples, the build unit 1002 is inserted in a compartment of the process room in a removable manner. For example, the build unit 1002 is to be removed from the printer for refilling.

The printer 1000 comprises a resistive load that is embedded in at least one of the heating devices as described below. The resistive load is to generate heat as a function of an applied voltage. The printer 1000 further comprises a control system, for example the control system 100, 400, 500 or 600, to control said resistive load. The control system of the printer 1000 functions as described above with respect to FIGS. 1 to 9. In the following, the example of the printer 1000 is described with reference to the functionalities of a 3D printer. However, the printer could also be a two-dimensional printer. Different printing technologies could be used, including but not limited to technologies of ink jet printing, liquid electrophoretic printing (LEP), offset printing, transfer printing, and other printing technologies.

According to some examples, the build unit 1002 includes a build material container (not shown) containing a build material to be used in a printing process. For example, the build material is provided in the form of powder. In some examples, the build unit 1002 has a build platform (not shown) on which the build material is disposed and processed. Further, the build unit 1002 may include a feed mechanism (not shown) that conveys the build material from the container to the build platform. In some examples, the build platform corresponds to a top surface of the build unit 1002.

The carriage 1004 is mounted on a rail 1006 that is fixed in the printer 1000. The carriage 104 is located above a top surface of the build unit 1002 and is movable along the rail 1006 in directions indicated by arrows A and B. For example, a motor controlled by a motor controller (both not shown) moves the carriage 1004 in the directions A and B. The build unit 1002 may be equipped with a build material distributor (not shown), combined with a feed mechanism if applicable. The build material distributor may dispose and distribute the build material layer-by-layer on the top surface of the build unit 102.

In some examples, the carriage 1004 includes a fusing agent distributor (not shown) which selectively dispenses drops of a liquid fusing agent or energy absorber onto defined areas on the layer of the build material that is disposed on the top surface of the build unit 1002. The fusing agent distributor may dispense the fusing agent while the carriage 1004 is moving, e.g. using inkjet printing technology. For example, the fusing agent fuses with the build material when exposed to heat and solidifies together with the fused build material when being cooled. A three-dimensional object may be manufactured by selectively fusing the fusing agent with the build material in defined areas, solidifying them by cooling and repeating the steps layer by layer. Unfused build material may be removed.

According to one example, a suitable fusing agent may be an ink-type formulation comprising copper blank, such as, for example, the ink formulation commercially known as CM997A available from Hewlett-Packard Company. In one example, such an ink may additionally comprise an infrared light absorber. One example, such an ink may additionally comprise a visible light absorber. Examples of inks comprising visible light absorbers are dye-based colored ink and pigment-based colored ink, such as inks commercially known as CE039A and CE042A available from Hewlett-Packard Company.

A heating device can be provided to deliver the energy to cause the solidification of portions of the build material where the fusing agent has been applied. In one example, the heating device employs an infrared or near-infrared light source. The infrared light is also referred to as heat radiation and causes a temperature increment when absorbed.

The carriage 1004 carries a first heating device 1008 for generating heat. The first heating device 1008 can be considered to be a resistive load. In different examples, the first heating device 1008 may comprise one heating lamp corresponding to one resistive load or an array of heating lamps corresponding to an array of resistive loads. A resistive load may refer to any part, unit or device that consumes electrical energy over an ohmic resistance. The electrical energy to be consumed may be supplied by a voltage applied across the resistive load and/or an electrical current through the resistive load. Examples for a resistive load include resistive heating elements, such as a heating lamp, e.g. an infrared or near-infrared lamp a glow filament, etc.

Any of the heating devices of the printer 1000 may comprise a single resistive load or an array of multiple resistive loads. Further, a heating device may correspond to a resistive load, as explained above. The heating device generates heat due to its ohmic resistance and an electrical current flowing through the respective resistive load under the applied voltage. The amount of heat generated by the heating device may to be varied by adjusting the voltage applied across the respective resistive load. Accordingly, the resistive load may have two or more operation states each corresponding to a specific amount of heat to be generated.

According to further examples, the carriage 1004 carries a second heating device 1010. The second heating device 1010 may be attached to the carriage 1004 on the opposite side to the first device 1008. The second heating device 1010 may have the same functional and structural features as the first device 1008. Also the second heating device 1010 has an ohmic resistance and generates heat when a voltage is applied. The second heating device 1010 allows for processing the build material while the carriage 1004 is moving in the direction B. Accordingly, the fusing agent distributor first dispenses the fusing agent, followed by the second heating device 1010 that applies heat for fusing the fusing agent with the build material. In some examples, the carriage 1004 carries both the first heating device 1008 and the second heating device 1010, thereby allowing the printer 1000 to process the build material while the carriage 1004 is moving in both directions A and B.

In some examples, the printer 1000 further comprises a top heating device 1012 located above the carriage 1004. The top heating device 1012 generates heat for preheating and maintaining a defined temperature level inside the process room in which the build material is processed. The top heating device 1012 may comprise a single resistive load or an array of resistive loads similar to the first heating device 1008 as described above. The resistive load of the top heating device 1012 has an ohmic resistance for generating heat when a voltage is applied.

Depending on the process stage of the printer 1000, each of the heating devices 1008-1012 operate at different operation states. The heating devices 1008-1012 may be in an “heating” state for generating heat, and in an “idle” state when no heat generation is required. For example, the voltage applied across the resistive load of the first heating device 108 is increased, e.g. to 100% of its nominal voltage, when the carriage 1004 is moving in the direction A and decreased to an idle level, e.g. 20% of the nominal voltage, when the carriage 1004 is moving in the direction B. Accordingly, the second heating device 1010 may be idle when the carriage 1004 is moving in the direction A and powered when the carriage 1004 is moving in the direction B. Both heating devices 1008, 1010 may be switched off when the carriage is not moving. The top heating device 1012 may be switched on when the build unit 1002 is inside the process chamber of the printer 1000 and switched off if no build unit 1002 is detected inside the printer 1000. Further, the top heating device 1012 may be switched on during a defined preheating time.

The ohmic resistance of the resistive load depends on the temperature. For example, the ohmic resistance of the resistive load has a positive temperature coefficient, i.e. the ohmic resistance increases with increasing temperature of the resistive load. When being idle, each of the heating devices 1008-1012 may become cold, thereby decreasing the respective ohmic resistance. When the resistive load initially is cold, the load initially has a lower ohmic resistance which increases with increasing temperature. As a consequence, assuming a constant voltage applied across the resistive load, the electrical current through the resistive load, when the load is cold, initially will have higher value which decreases with increasing temperature and hence increasing ohmic resistance of the resistive load. For example, if the resistive load is switched on while being cold, a relatively high current will flow through the resistive load because the load will have a low ohmic resistance.

In this regard, the printer 1000 or its controller determines a resistance value of the respective resistive load of the heating devices 1008-1012 and estimates the in-rush current that would occur when instantly switching to the target voltage value. If the in-rush electrical current is larger than the maximum admissible electrical current of the respective resistive load, the resistive load may suffer damage, thereby shortening its life span. The controller may then decide not to instantly switch to the target voltage value, but to gradually increase the voltage applied across the resistive load in accordance with a ramp or step function. Further, it is possible to detect the electrical current through the resistive load and to take into account the detected electrical current when changing the voltage applied across the resistive load, as described above.

As a result, when transitioning the voltage that is applied across the resistive load 1008-1012 from the initial voltage value to the target voltage value, the resistance value is determined and taken into account in the decision as to whether the applied voltage can be instantly switched to the target voltage value. One of the plurality of voltage transition modes may be selected so as to transition the applied voltage as fast as possible without exceeding the maximum admissible electrical current through the respective resistive load.

1.-15. (canceled)

16. A printer, comprising:
a resistive load; and
a control system to control the resistive load; wherein
the control system is to determine a resistance value of the resistive load;
the control system is to determine a voltage transition mode for transitioning the voltage applied across the resistive load to a target voltage value depending on the resistance value; and
wherein the control system is to transition the voltage applied across the resistive load to the target voltage value according to the determined voltage transition mode.

17. The printer of claim 16, wherein the control system is to determine a voltage transition mode from a plurality of different voltage transition modes; and wherein the plurality of different voltage transition modes comprises at least two of:
instantly switching the voltage applied across the resistive load to the target voltage value;
gradually transitioning the voltage applied across the resistive load from the initial voltage value to the target voltage value according to a linear ramp;
gradually transitioning the voltage applied across the resistive load from the initial voltage value to the target voltage value according to a nonlinear ramp; and
stepwise transitioning the voltage applied across the resistive load from the initial voltage value to the target voltage value.

18. The printer of claim 17, further comprising a storage device for storing the plurality of voltage transition modes.

19. The printer of claim 16, further comprising a current sensor to measure an electrical current through the resistive load, wherein the control system is to determine the resistance value as a function of the measured electrical current.

20. The printer of claim 16, wherein:
the control system is to calculate an in-rush electrical current through the resistive load which would be generated when instantly switching the voltage across the resistive load from the initial voltage value to the target voltage value, taking into account the determined resistance value of the resistive load;
the control system is to perform a comparison of the calculated in-rush electrical current with an admissible electrical current through the resistive load; and
the control system is to determine the voltage transition mode depending on a result of the comparison.

21. The printer of claim 16, wherein:
the resistive load is to generate heat based on an ohmic resistance of the resistive load and the voltage applied across the resistive load, and
the control system is to control the amount of heat generated by the resistive load by changing the target voltage across the resistive load.

22. A method of controlling a voltage applied across a resistive load, comprising:
receiving a target voltage value to be applied across the resistive load;
determining a resistance value of the resistive load; and
transitioning the voltage across the resistive load from an initial voltage value to the target voltage value based on the determined resistance value of the resistive load.

23. The method of claim 22, further comprising:
calculating an in-rush electrical current through the resistive load which would be generated by instantly switching the voltage applied across the resistive load from the initial voltage value to the target voltage value, taking into account the determined resistance value of the resistive load; and
instantly switching the voltage applied across the resistive load from the initial voltage value to the target voltage value, if the calculated in-rush electrical current is below an admissible electrical current through the resistive load.

24. The method of claim 22, further comprising:
calculating an in-rush electrical current through the resistive load which would be generated when instantly switching the voltage applied across the resistive load from the initial voltage value to the target voltage value, taking into account the determined resistance value of the resistive load; and
gradually transitioning the voltage across the resistive load from the initial voltage value to the target voltage value, if the calculated in-rush electrical current is at or above an admissible electrical current through the resistive load.

25. The method of claim 24, wherein gradually transitioning the voltage applied across the resistive load from the initial voltage value to the target voltage value comprises transitioning the voltage applied across the resistive load in accordance with a linear ramp or a nonlinear ramp or a step function.

26. The method of claim 22, wherein determining the resistance value of the resistive load comprises:
determining the initial voltage across the resistive load;
measuring an electrical current through the resistive load,
calculating the resistance value of the resistive load based on the initial voltage value and the measured electrical current.

27. The method of claim 22, wherein the resistance value of the resistive load, in a stable state, is determined based on a function of the voltage applied across the resistive load to the power of X1, multiplied with a nominal voltage of the resistive load to the power of X2 and divided by a nominal power of the resistive load,
wherein X1 is about 0.46, and
wherein X2 is about 1.54.

28. The method of claim 22, further comprising calculating an admissible voltage change per time unit corresponding to an admissible electrical current through the resistive load, taking into account the determined resistance value of the resistive load.

29. The method of claim 22, further comprising:
generating heat by applying the voltage across the resistive load; and
varying the amount of heat generated by the resistive load by controlling the voltage applied across the resistive load according to the target voltage value.

30. A control system to control a resistive load, comprising:
a controller to control a voltage applied across the resistive load;
wherein the resistive load is to generate heat based on the voltage applied across the resistive load and a resistance value of the resistive load;
wherein the control system is to control the amount of heat generated by the resistive load by changing the voltage applied across the resistive load to a target voltage value;
wherein the controller is to determine the resistance value of the resistive load; and
wherein the controller is to select, depending on the determined resistance value of the resistive load, one of a plurality of different voltage transition modes for transitioning the voltage applied across the resistive load from an initial voltage value to a target voltage value.
